(19) United States
(12) Patent Application Publication
(10) Pub. No.: US 2013/0280588 A1
(43) Pub. Date: Oct. 24, 2013

(54) BATTERY MODULE HAVING REDUCED TOTAL INDUCTANCE

(71) Applicants: Peter Feuerstack, Ludwigsburg (DE); Erik Weissenborn, Stuttgart (DE); Martin Kessler, Schwaebisch Gmuend (DE)

(72) Inventors: Peter Feuerstack, Ludwigsburg (DE); Erik Weissenborn, Stuttgart (DE); Martin Kessler, Schwaebisch Gmuend (DE)

(73) Assignee: ROBERT BOSCH GMBH, Stuttgart (DE)

(21) Appl. No.: 13/977,901

(22) PCT Filed: Nov. 14, 2011
(86) PCT No.: PCT/EP11/70014

§ 371 Date: Jul. 1, 2013

(30) Foreign Application Priority Data
Dec. 29, 2010 (DE) 10 2010 064 303.3

(51) Int. Cl. H01M 2/20

(52) U.S. Cl. CPC H01M 2/202
USPC 429/158

(57) ABSTRACT

The invention relates to a battery module (1), comprising at least two battery cells (2), each having a first (3) and a second connection (4), connector connecting elements (7) for connecting the battery cells (2), a first (9) and a second terminal connector (11) for connecting the battery module (1) to external circuitry, a first terminal connector connecting element (8) for connecting the first terminal connector (9) to a first terminal (5) of the battery module (1), and a second terminal connector connecting element (10) for connecting the second terminal connector (11) to a second terminal (6) of the battery module (1). The second terminal connector connecting element (10) has a planar design and is arranged in such a manner that the surface thereof runs spaced from and substantially parallel to connector connecting elements (7) and covers said elements at least in sub-regions, and that during operation a current flows through the second terminal connector connecting element (10), the direction of the current being substantially opposite the current flow direction in the connector connecting elements (7).

### BACKGROUND OF THE INVENTION

The invention relates to a battery module.

In order to be able to build a battery module with an increased capacity, a plurality of battery cells can be connected in series. In the majority of areas where battery modules are used, disregarding a low ripple proportion, approximately direct current is drawn off from and/or supplied to said battery modules.

U.S. Pat. No. 5,642,275 A discloses a battery system having an integrated alternating current converting function, in which a row of circuit breakers having separate direct current voltage sources in the form of batteries is provided. Battery systems of this type that are also frequently described as multilevel cascaded inverters render it possible to achieve single-phase or multi-phase systems that comprise a higher degree of efficiency and a higher level of reliability than conventional alternating current converting arrangements.

However, if a battery system of this type is used for example to control an electric machine, a quick conversion of the current flowing through and/or bypassing the direct current voltage sources is required in order to vary the phase voltage. However, as the proportion of the current being converted increases, so does the influence of the inductance of the direct current voltage sources and as a result when using battery modules the influence of the inductance of the interconnections of the individual battery cells also increases. In particular, distributed module inductances in combination with high currents during switching operations lead to a high level of energy dissipation that is converted into heat in the circuit breakers. As a consequence of the repeated occurrence of switch operations, this leads to high thermal dissipation in the switches and consequently to a reduced degree of efficiency of the battery system. In some applications an excessively high inductive proportion of the impedance of a battery module also makes an additional buffer capacity necessary.

Electromagnetic fields associated with distributed module inductances are also emitted during each switch operation; without corrective measures this could lead to malfunctions in adjacent electronic components, so that complex additional switch measures are often necessary in order to comply with EMC regulations (EMC=electromagnetic compatibility).

### SUMMARY OF THE INVENTION

The present invention provides a battery module comprising

at least two battery cells that comprise in each case a first connection and a second connection,

connection connecting elements for electrically connecting the at least two battery cells, wherein each connection connecting element connects a first connection of a first battery cell to a second connection of a second battery cell, which second connection is preferably adjacent to said first connection,

a first terminal connection and a second terminal connection for connecting the battery module to external circuitry,

a first terminal connection connecting element for electrically connecting the first terminal connection to a first terminal of the battery module, wherein the first terminal is embodied by way of a first connection of a first battery cell, and

a second terminal connection connecting element for electrically connecting the second terminal connection to a second terminal of the battery module, wherein the second terminal is embodied by way of a second connection of a second battery cell.

In this case, the second terminal connection connecting element is embodied in a planar manner and is arranged in such a manner that the surface thereof extends at a spaced disposition from and fundamentally parallel to the connection connecting elements and covers said elements at least partially and that during the operation of the battery module a current flows through the second terminal connection connecting element, the direction of said current being fundamentally opposite to a current flow direction in the connection connecting elements.

### Advantages of the Invention

The total inductance of a battery module is defined on the one hand by the inductances of the individual battery cells (cell inductances) and on the other hand by the inductance of the interconnections of said battery cells. The invention is based on the fundamental idea that, in the case of a battery module that comprises a plurality of battery cells that are connected in series, the individual battery cells are interconnected in such a manner that the contribution of the interconnections to the total inductance of the battery module assumes a negligible value with respect to the cell inductances.

This is fundamentally achieved in accordance with the invention by virtue of the fact that the second terminal connection connecting element is embodied in a planar manner and is arranged in such a manner that the surface thereof extends at a spaced disposition from and fundamentally parallel to the connection connecting elements and covers said elements at least partially and that during the operation of the battery module a current flows through the second terminal connection connecting element, the direction of said current being fundamentally opposite to a current flow direction in the connection connecting elements.

By virtue of the planar current flow and the partial covering in the case of the opposite direction of the current flow, a magnetic interaction between the connection connecting elements and the second terminal connection connecting element is produced which gives rise to a considerable reduction of the inductance that results from the interconnections. This in turn leads to a reduced thermal dissipation in the circuit breakers and therefore to an increased degree of efficiency of the battery system. The construction of the battery module in accordance with the invention concentrates the magnetic field onto the area between the connecting elements and the second terminal connection connecting element and therefore minimizes the number of electromagnetic malfunctions.

These effects can be further enhanced in that the connection connecting elements are likewise embodied in a planar manner and the second terminal connection connecting element is arranged in such a manner that the surface thereof extends fundamentally parallel to the surfaces of the connection connecting elements.

The ohmic losses of the cell interconnections are divided between direct current and alternating current losses. As a result of the planar current flows, even low material thicknesses are sufficient for the terminal connection connecting elements in order to achieve negligible resistance values for the direct current, so that the battery module in accordance with the invention is not only characterized by a low inductance of the interconnections but also by an extremely low resistance connection of the battery cells.

The low material thickness in relation to the width of the connecting elements further produces a favorable cross section in order to reduce the influence of the skin effect, so that the battery module in accordance with the invention also comprises a reduced loss resistance in the case of an alternating current operation.

The above-mentioned effects can be further improved in that the surface of the second terminal connection connecting element covers at least 80% of the surfaces of the connection connecting elements. A further improvement is achieved if the surface of the second terminal connection connecting element completely covers the surfaces of the connection connecting element.

Additionally, the first terminal connection connecting element can also be embodied in a planar manner. A further reduction of the parasitic inductances and resistances of the battery module can then be achieved by virtue of the fact that the surface of the second terminal connection connecting element also extends parallel to the surface of the first terminal connection connecting element and also covers said element at least partially, so that it also produces an advantageous magnetic interaction between the two terminal connection connecting elements.

It is possible to implement the invention in a particularly simple manner using manufacturing technology if the first terminal connection connecting element is embodied as one part with the first terminal connection and/or the second terminal connection connecting element is embodied as one part with the second terminal connection.

In order to achieve low inductive interconnections in the area of the terminal connections, the first terminal connection can be arranged in the proximity of the second terminal connection, in particular adjacent to the second terminal connection. In this case, it is particularly preferred that the first terminal connection at least partially covers the second terminal connection.

In order to form the magnetic interaction between the connection connecting elements and the second terminal connection connecting element and/or between the first terminal connection connecting element and the second terminal connection connecting element as effectively as possible, the gap between these units is kept as small as possible. This can be achieved in a simple manner by virtue of the fact that an insulating layer is arranged between the second terminal connection connecting element and the connection connecting elements and/or between the first terminal connection connecting element and the second terminal connection connecting element.

It is necessary for some applications for connections of individual battery cells to be able to establish a contact for example for sensors, attenuators or balancing circuits. In order to avoid the connections of this type being completely covered by connection connecting elements and/or the terminal connection connecting elements, the connections of individual battery cells can be embodied in accordance with an embodiment of the invention at least partially in such a manner that an additional external contact to at least one connection of a battery cell can be established. The construction of the battery module in accordance with the invention has in this case the advantage that external circuit components of this type can also be connected in a manner which produces extremely low resistance and low inductance.

A cover can be provided in order to cover the battery module externally, which cover covers the terminal connection connecting elements on the face remote from the battery cells.

Further features and advantages of embodiments of the invention are evident in the following description with reference to the attached drawings.

### BRIEF DESCRIPTION OF THE DRAWINGS

In the drawings:

FIG. 1 illustrates a schematic representation of battery cells of a battery module in accordance with the invention after the connection connecting elements have made contact with the connections,

FIG. 2 illustrates a schematic representation of the battery cells in accordance with FIG. 1 after an insulating layer has been applied,

FIG. 3 illustrates a schematic representation of the battery cells in accordance with FIG. 1 after the second terminal connection connecting element has made contact with the connection, and

FIG. 4 illustrates a schematic representation of the battery cells in accordance with FIG. 1 after a cover has been applied.

### DETAILED DESCRIPTION

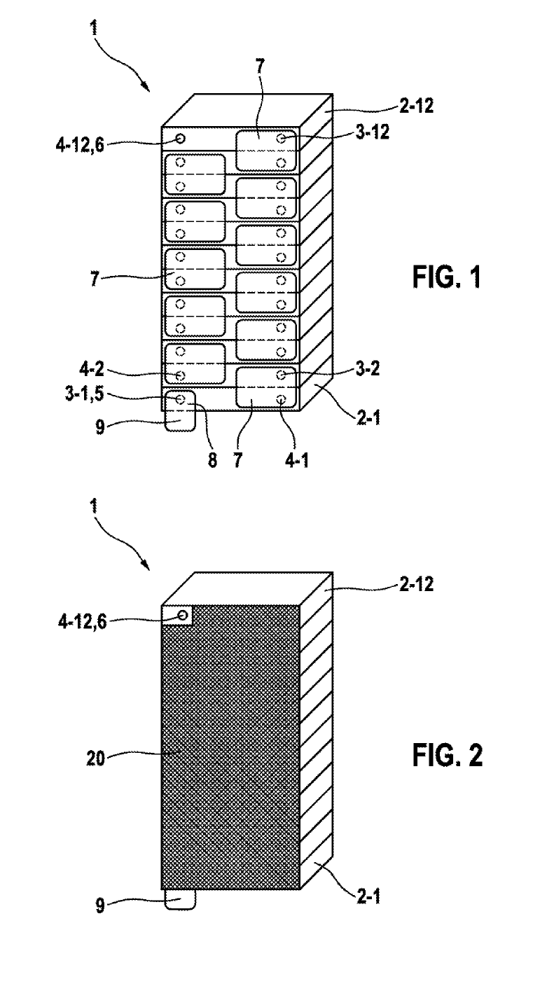

A battery module 1 illustrated schematically in FIG. 1 comprises a plurality of battery cells 2-1 to 2-12, twelve in the illustrated exemplary embodiment, that are advantageously embodied as rechargeable battery cells or secondary battery cells. In this case, for the sake of clarity only the two outer battery cells 2-1 and 2-12 are provided with reference numerals. Each battery cell 2 comprises a first positive connection 3 and a second negative connection 4. The individual battery cells 2-1 to 2-12 are arranged in such a manner that the connections 3, 4 form two parallel linear rows, wherein in each case first connections 3 and second connections 4 alternate.

The first connection 3-1 of the battery cell 2-1 lying at the bottom in the figure and the second connection 4-12 of the battery cell 2-12 lying at the top in the figure are used as the first (positive) terminal 5 and/or the second (negative) terminal 6 of the battery module 1. The remaining connections 3 and 4 are electrically connected in each case in pairs with the aid of connection connecting elements 7. A first connection 3 of a first battery cell 2-i is connected in each case to an adjacent second connection 4 of a second battery cell 2-(i+1) so that individual battery cells 2 are connected in series.

The connection 3-1 of the lowest battery cell 2-1, said connection being used as the first terminal 5 of the battery module 1, is connected to a first terminal connection 9 by way of a first terminal connection connecting element 8. In the illustrated exemplary embodiment the first terminal connection connecting element 8 is embodied as one part with the associated first terminal connection 9.

In accordance with the illustrated embodiment, the connection connecting elements 7 and also the first terminal connection connecting element 8 are embodied in a planar manner. The connection connecting elements 7 can comprise, as is illustrated, a standardized exterior shape; they can also, however, be embodied in different ways. However, it is advantageous if they cover as large an area as possible.

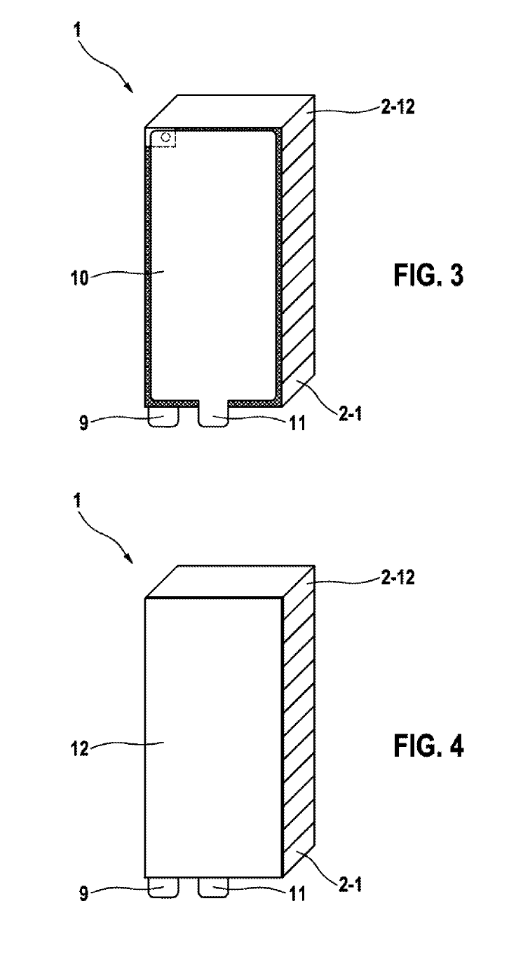

An insulating layer 20 is applied to the connection connecting elements 7 and the first terminal connection connecting element 8 (cf. FIG. 2), which insulating layer is used for the purpose of producing a pre-defined gap between the connection connecting elements 7 and/or the first terminal connection connecting element 8 and a second terminal connection connecting element 10 (cf. FIG. 3). The second connection 4-12 of the battery cell 2-12 that lies at the top in the figure is used as the second terminal 6 of the battery module 1 and, in order to render it possible for the second connection 4-12 to be contacted, the insulation layer 20 is cut out in this area.

The second terminal connection connecting element 10 is used to provide the electrical connection between the connection 4-12 of the top battery cell 2-12 and a second terminal connection 11, which connection 4-12 is used as the second terminal 6 of the battery module 1. The terminal connections 9 and 11 are used in order to connect the battery module 1 to external circuitry, for example in the form of circuit breakers. In the illustrated exemplary embodiment, the second terminal connection connecting element 10 is embodied as one part with the associated second terminal connection 11.

The second terminal connection connecting element 10 is in accordance with the invention embodied in a planar manner and arranged in such a manner that the surface thereof (by way of the insulating layer 20) extends at a spaced disposition from and fundamentally parallel to the surfaces of the connection connecting elements 7 and the surface of the first terminal connection connecting element 8. In this case, the connection connecting elements 7 are completely covered and the first terminal connection connecting element 8 is at least partially covered. During operation of the battery module 1, a current flows through the second terminal connection connecting element 10, the direction of said current being fundamentally opposite to the current flow direction in the connection connecting elements 7 and in the first terminal connecting element 8.

The planar current flow and the at least partial covering of the second terminal connection connecting element 10 with the connection connecting elements 7 and the first terminal connection connecting element 8 cause a magnetic interaction between these components. The opposite direction of the current flow leads to the resulting magnetic fields being largely balanced so that inductance of the battery module 1 that results from the battery cell interconnections is considerably reduced.

In order to further reduce the inductance of the battery cell interconnections, both terminal connections 9 and 11 are arranged adjacent to one another, so that they comprise as small a gap as possible. As an alternative to the illustrated embodiment, both terminal connections 9 and 11 can even partially overlap, so that the advantageous magnetic interaction is also enhanced in this area.

In order to render it possible for individual connections 3 and/or 4 of individual battery cells 2 to establish a contact, for example for sensors, attenuators or balancing circuits, the individual connection connecting elements or else all connection connecting elements 7 and/or the terminal connection connecting elements 8, 10 can also comprise corresponding cut-outs.

In order to cover the battery module externally, a cover 12 is applied in a closing manner to the second terminal connection connecting element 10 on the face of the battery module 1 that is remote from the battery cells 2. In so doing, the entire battery module 1 is fundamentally covered. Only those terminal connections 9 and 11 that are used to contact an external circuitry component protrude beyond the cover 12.

1. A battery module (1) comprising
at least two battery cells (2) that comprise in each case a first connection (3) and a second connection (4),
connection connecting elements (7) for electrically connecting the at least two battery cells (2), wherein each connection connecting element (7) connects a first connection (3) of a first battery cell (2-i) to a second connection (4) of a second battery cell (2-(i+1)),
a first terminal connection (9) and a second terminal connection (11) for connecting the battery module (1) to external circuitry,
a first terminal connection connecting element (8) for electrically connecting the first terminal connection (9) to a first terminal (5) of the battery module (1), wherein the first terminal (5) is embodied by way of a first connection (3-1) of a first battery cell (2-1), and
a second terminal connection connecting element (10) for electrically connecting the second terminal connection (11) to a second terminal (6) of the battery module (1), wherein the second terminal (6) is embodied by way of a second connection (4-12) of a second battery cell (2-12),
wherein the second terminal connection connecting element (10) is embodied in a planar manner and arranged in such a manner that a surface thereof extends at a spaced disposition from and fundamentally parallel to the connection connecting elements (7) and covers said elements at least partially, and that during the operation of the battery module (1) a current flows through the second terminal connection connecting element (10), the direction of said current being fundamentally opposite to a current flow direction in the connection connecting elements (7).

2. The battery module as claimed in claim 1, wherein the connection connecting elements (7) are likewise embodied in a planar manner and the second terminal connection connecting element (10) is arranged in such a manner that the surface thereof extends fundamentally parallel to surfaces of the connection connecting elements (7).

3. The battery module as claimed in claim 2, wherein the surface of the second terminal connection connecting element (10) covers at least 80% of the surfaces of the connection connecting elements (7).

4. The battery module as claimed in claim 1, wherein the first terminal connection connecting element (8) is likewise embodied in a planar manner.

5. The battery module as claimed in claim 4, wherein the surface of the second terminal connection connecting element (10) also extends parallel to a surface of the first terminal connection connecting element (8) and also covers said first terminal connection connecting element at least partially.

6. The battery module as claimed in claim 1, wherein the first terminal connection connecting element (8) is embodied as one part with the first terminal connection (9) and/or the second terminal connection connecting element (10) is embodied as one part with the second terminal connection (11).

7. The battery module as claimed in claim 1, wherein the first terminal connection (9) is arranged in the proximity of the second terminal connection (11).

8. The battery module as claimed in claim 7, wherein the first terminal connection (9) covers the second terminal connection (11) at least partially.

9. The battery module as claimed in claim 1, wherein an insulating layer (20) is arranged between the second terminal connection connecting element (10) and the connection connecting elements (7) and/or between the first terminal connection connecting element (8) and the second terminal connection connecting element (10).

10. The battery module as claimed in claim 1, wherein the connection connecting elements (7) and/or the terminal connection connecting elements (8, 10) are at least partially embodied in such a manner that an additional external contact to at least one connection (3; 4) of a battery cell (2) can be established.

11. The battery module as claimed in claim 1, wherein the terminal connection connecting elements (8, 10) are covered on a face that is remote from the battery cells by a cover (12).

12. The battery module as claimed in claim 1, wherein the second connection is adjacent to said first connection.

13. The battery module as claimed in claim 2, wherein the surface of the second terminal connection connecting element (10) completely covers the surfaces of the connection connecting elements (7).

14. The battery module as claimed in claim 1, wherein the first terminal connection (9) is arranged adjacent to the second terminal connection (11).
